(19) United States
(12) Patent Application Publication
(10) Pub. No.: US 2007/0064004 A1
(43) Pub. Date: Mar. 22, 2007

(54) Moving a graphic element

(75) Inventors: Matthew Ryan Bonner, Vancouver, WA (US); Jonathan J. Sandoval, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Fort Collins, CO (US)

(21) Appl. No.: 11/233,166

(22) Filed: Sep. 21, 2005

(51) Int. Cl. G06T 11/20

(52) U.S. Cl. 345/442

(57) ABSTRACT

Embodiments of moving a graphic element are disclosed.

### CROSS-REFERENCE TO RELATED APPLICATION

This application is related to co-pending and commonly assigned application Ser. No. 11/018,187, filed Dec. 20, 2004 (attorney docket no. 200401396-1, “Interpreting an Image” by Jonathan J. Sandoval, Michael Blythe, and Wyatt Huddleston), the entire disclosure of which is incorporated herein by reference. The copyright notice above applies equally to copyrightable portions of the material incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Current windowing systems offer little to enable shared views or collaborative development. Systems have been made which place all applications on a desktop display that can be rotated as a whole by users. On a small tabletop display, this may be sufficient, but it scales poorly to multiple users at a large tabletop display.

### BRIEF DESCRIPTION OF THE DRAWINGS

The features and advantages of the disclosure will readily be appreciated by persons skilled in the art from the following detailed description when read in conjunction with the drawings, wherein:

FIG. 1 is a top plan view of an embodiment of a tabletop with an embodiment of a single shared tabletop interactive display surface.

FIG. 2 is a top plan view of an embodiment of a shared tabletop with an embodiment of two interlinked interactive display surfaces.

FIG. 3 is a top plan view of an embodiment of a shared tabletop with an embodiment of multiple interlinked interactive display surfaces.

FIG. 4 is a high-level flowchart illustrating an embodiment of a method for controlling graphic-element propulsion.

FIG. 5 is a schematic diagram illustrating an embodiment of a software-displayed map used to direct selective sharing of information associated with graphic elements.

### DETAILED DESCRIPTION OF EMBODIMENTS

For clarity of the description, the drawings are not drawn to a uniform scale. In particular, vertical and horizontal scales may differ from each other and may vary from one drawing to another. In this regard, directional terminology, such as “top,” “bottom,” “front,” “back,” “leading,” “trailing,” etc., is used with reference to the orientation of the drawing figure(s) being described. Because components of the various embodiments can be positioned in a number of different orientations, the directional terminology is used for purposes of illustration and is in no way limiting.

The term “graphic element” is used throughout this specification and the appended claims to mean any graphical representation of an object or entity. For example, images, icons, “thumbnails,” and avatars are graphic elements, as are any graphical representations of files, documents, lists, applications, windows, system hardware components, system software components, game pieces, notes, reminders, drawings, calendars, database queries, results of database queries, graphic elements representing financial transactions such as auction bids, etc. Graphic elements may include text or other symbols, e.g., the number, title, and/or a selected page shown on a representation of a document. If an object-oriented system of programming is used to implement an embodiment, graphic elements may be represented by objects and classes in the object-oriented sense of those terms.

The term “token” refers to an arbitrary physical object capable of interacting with an interactive/collaborative display. For example, two general classes of tokens include tools and game pieces. Tools may refer, variously, to objects used to indicate specific actions to be performed on graphic elements or objects used to invoke application-specific features, for example.

While example embodiments may be described in terms of particular window control systems for particular computer operating systems, such embodiment descriptions are examples and should not be interpreted as limiting embodiments to any particular window control system or operating system.

For reasons of simplicity and clarity, this description assumes that no transfers of graphic elements or of the entities they represent among users of embodiments involve issues of copyright ownership or digital rights management (DRM). If such issues occur in a particular application of the embodiments, they may be dealt with in an appropriate manner.

One embodiment provides a method of controlling graphic-element propulsion in a system including a display with a touch screen. A gesture performed on the surface of the touch-screen display is detected, a graphic element displayed on the display is associated with the gesture, the gesture is characterized by at least one motion value, and the display is updated to propel the graphic element in accordance with the motion value. Various embodiments described herein illustrate, among others, these three related uses: flicking a graphic element on a screen, automatically rotating the flicked graphic element to a suitable orientation, and flicking a graphic element across multiple connected interactive display tables.

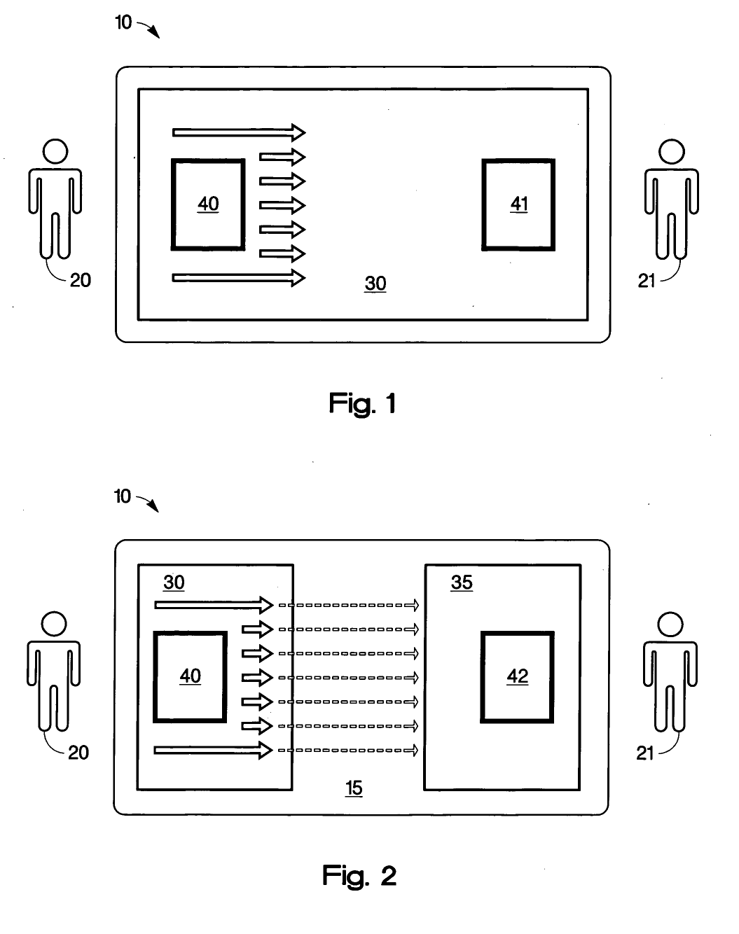

FIG. 1 shows an embodiment of an interactive/collaborative display table 10, with two users 20 and 21 interacting with a touch-screen-equipped display surface 30. User 20 has a graphic element 40 on his or her portion of display surface 30. By making a hand gesture on the touch screen, user 20 can “flick” graphic element 40 across table 10 to user 21, with the result that graphic element 41 (e.g., a copy of graphic element 40) appears, correctly oriented, in the portion of display surface 30 that is facing user 21.

When using their hands on a touch screen, users want to be able to gesture intuitively to affect application windows, displayed graphic elements within an application window, and other on-screen graphic elements. On a large screen or on multiple screens networked together, users want a means to pass on-screen graphic elements to each other. For example, users in a conference room want a way to pass on-screen graphic elements between networked interactive/collaborative display tables. Meeting attendees often want to share information privately and discretely without interrupting a speaker.

Technology limitations have tended to constrain meetings to a simple “speaker-audience” model, which may be appropriate under an implied premise that one person in the room has all the information of interest, and others have none, but such a premise is not always appropriate. On the other hand, an interactive/collaborative-display-enabled conference room enables interaction and collaboration, where content may be shared by all attendees in real time. Often, during a meeting, the desire arises for a piece of information held by someone not attending. An interactive/collaborative-display-table in a conference room may allow meeting participants to share information with networked computers outside of the conference room and allows participants to request additional data.

Outside the context of meetings, the use of multiple-interactive/collaborative display tables allows for easy sharing of information across large display surfaces. In a basic case, auto-rotation of on-screen graphic elements implements orienting of propelled graphic elements properly to the receiving user. Most window applications and graphic elements within an application have an orientation, e.g., the orientation appropriate to displayed text. Since an interactive/collaborative display system allows users access to all sides of its display, many applications present the challenge of implementing a clear orientation toward users on any side. Most software applications will benefit from a way to orient screen graphic elements toward a user who is located at an arbitrary position, which may be a position around an interactive/collaborative display table.

A system incorporating backside vision enables multiple users to interact with a large touch screen, using one finger or multiple fingers, while multiple graphic elements are simultaneously active. Such direct interaction allows users to control on-screen elements in an intuitive manner.

One aspect of the embodiments described herein is that these embodiments enable window systems, graphic elements, and application window behaviors that respond to user gestures. On a single interactive/collaborative display system and/or on multiple interactive/collaborative display systems, these embodiments include the capability for a user to transfer or “flick” graphic elements to a desired location or to a selected user in an intuitive manner. The possibility of a user's flicking items to multiple other users raises the issue of proper orientation, depending on the intended location of the graphic element. In the descriptions of various embodiments, implementation of correctly orienting a window or graphic element for a user is also addressed. The flicking operation is then extended to span multiple connected interactive/collaborative display-system tables, which may be widely separated or may be located near each other, e.g., in a common room.

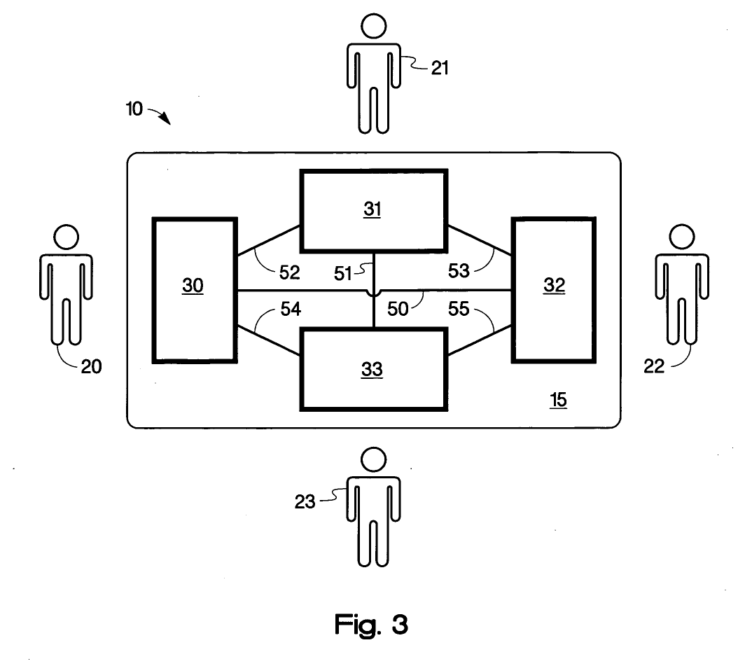

FIG. 2 shows another embodiment of an interactive/collaborative display table 10, with two users 20 and 21 interacting with two separate touch-screen-equipped display surfaces 30 and 35. Display surfaces 30 and 35 are logically interlinked by wired or wireless interconnections described below. Table 10 may have a non-interactive portion 15. User 20 has a graphic element 40 on display surface 30. By making a hand gesture on the touch screen of display surface 30, user 20 can “flick” graphic element 40 across table 10 (in effect passing over non-interactive portion 15) to user 21, with the result that graphic element 42 (e.g., a copy of graphic element 40) appears, correctly oriented, on display surface 35 that is facing user 21. A suitable hand gesture made by user 20 to flick graphic element 40 may comprise, for example, initially touching graphic element 40 with a tip of a bent finger, then quickly straightening the finger in the direction of user 21 with sustained acceleration while keeping the fingertip in contact with the touch-screen-equipped display surface, lifting the fingertip from display surface 30 at the end of the flicking gesture.

Once a destination for a graphic element is determined, the correct orientation is fixed by reference to a particular location on the interactive/collaborative display table or on multiple interactive/collaborative display tables that are interconnected. That particular location may be an absolute location on a display surface 30 of an interactive/collaborative display table 10.

FIG. 3 shows another embodiment of an interactive/collaborative display table 10, with four users 20-23 interacting with four separate touch-screen-equipped display surfaces 30-33. Again, table 10 may have a non-interactive portion 15. Display surfaces 30, 31, 32, and 33 are logically interlinked by wired or wireless interconnections 50-55 as shown schematically in FIG. 3. Logical interconnections 50-55 may or may not connect the displays directly pair-wise as illustrated, but these logical interconnections may be made by one or more shared or networked processors, for example, which accept inputs from each display and send outputs to each display. For example, each display surface 30, 31, 32, and 33 may have its own processor, and those four processors (not explicitly shown) may be networked by an available standard or special-purpose wired or wireless network or may be networked with a single processor serving interactive/collaborative display table 10. Such network interconnections are also represented by the logical interconnections 50-55 shown in FIG. 3.

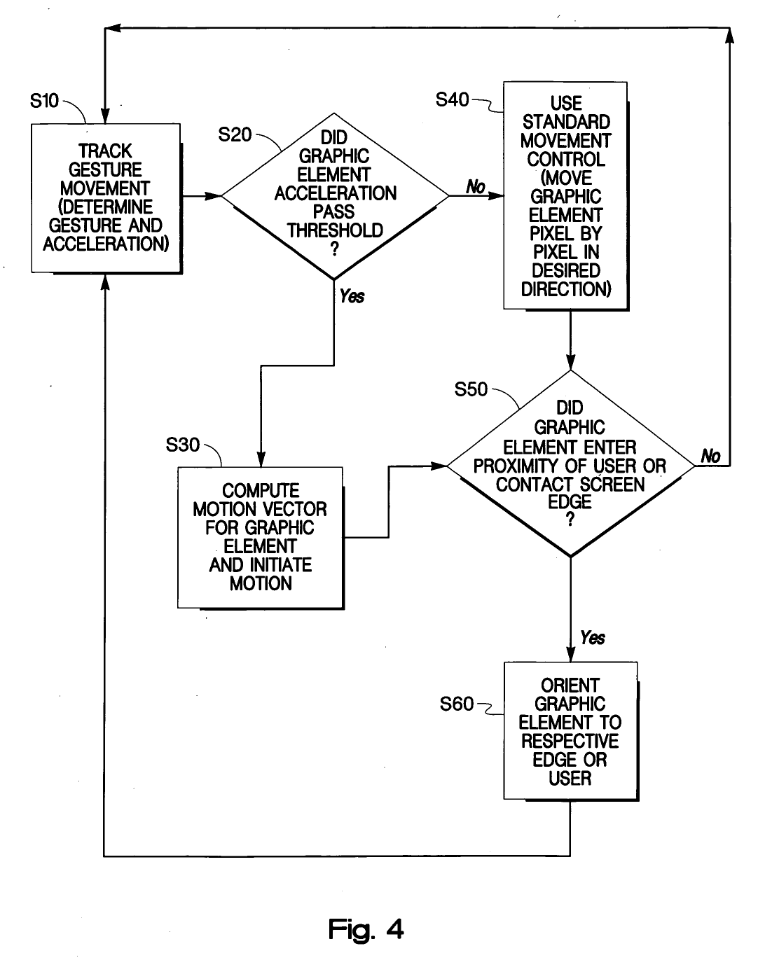

FIG. 4 is a high-level flowchart illustrating an embodiment of a method for controlling graphic-element propulsion. Steps of the method are denoted by reference numerals S10, . . . , S60. Transitions between steps are shown by the arrows. The reference numerals may or may not imply a time sequence, as the order of steps may be varied considerably, and the order of executions depends upon the results of decisions. Step S10 comprises tracking gesture movement, i.e., detecting that a gesture has occurred, characterizing the type of gesture, and characterizing the gesture as to its motion values. Motion values determined in step S10 can include time of initiating the gesture, an initial position of the gesture, initial speed of the gesture, one or more directions of the gesture, initial velocity of the gesture, acceleration of the gesture, final velocity of the gesture, an ending position of the gesture, ending time of the gesture, and combinations of two or more of these values. Since there may be more than one graphic element displayed on the interactive display surface, the initial position of the gesture is used to determine which graphic element is involved in the gesture. In step S20, a decision occurs as to whether the gesture indicates an acceleration of the graphic element that exceeds a predetermined threshold. If the acceleration does not exceed the predetermined threshold value (result=NO), step S40 is performed. In step S40, standard movement control is employed, i.e., the graphic element is moved pixel-by-pixel in a desired direction as determined by the gesture's initial velocity and/or instantaneous position and stopped when the gesture ends. If the acceleration does exceed the predetermined threshold value (result of step S20=YES), step S30 is performed. In step S30, the motion vector for propulsion of the pertinent graphic element in the desired direction is computed and the motion of the graphic element is initiated.

In either path after decision step S20, the instantaneous position of the graphic element in its motion is checked in step S50 to determine if the graphic element has contacted a screen edge or has entered an interactive-display-surface portion belonging to a particular user (result of S50=YES), either condition being sufficient to stop the motion of the graphic element and (in at least some embodiments) to orient the graphic element. Normally, in step S60 the graphic element would be oriented to the respective edge of the display and/or toward the selected user. No orientation would be relevant for a circularly symmetric graphic element without orientation, for example (e.g., a graphic element having no text content). If the result of step S50 is NO, gesture tracking of step S10 continues. If the result of step S50 is YES, orientation step S60 is performed and gesture tracking of step S10 continues.

### EXAMPLES

A first example embodiment illustrates graphic element propulsion via manual acceleration. When the interactive/collaborative display tracks a finger moving a window via a designated portion of the window, such as the title bar or other predetermined locations, it will monitor the velocity and acceleration. The interactive/collaborative display will interpret sustained acceleration of the graphic element followed immediately by breaking contact with the graphic element, as a propulsion command. The “propulsion” feature is enabled in the system settings, and users can adjust the acceleration and distance sensitivity. Friction between fingers and the screen may cause the control token to “jump” or momentarily release control from a graphic element. Thus, graphic element propulsion has the potential to appear to the interactive/collaborative display like repeated “click,” “drag” or other mouse actions. To some extent, this may pertain regardless of the kind and number of heuristics or rules the interactive/collaborative display employs to interpret user actions. The interactive/collaborative display may use, among others, the following classes of heuristics and specific rules to interpret user actions with reduced likelihood of ambiguity. The heuristics given here as examples are first listed briefly, and then described in more detail hereinbelow:
A. the time between user contact with a graphic element and any attempt to move the element,
B. whether any meaning exists for moving an on-screen graphic element or its containing objects,
C. the amount or portion of the graphic element covered by user contact, and
D. probabilistic computation of the most likely action intended by the user.

Heuristic A relates to determining whether or not the user intends to move the graphic element, e.g., to distinguish accidental contact from intentional contact.

Heuristic B relates to the “mobility” of graphic elements. For example, in Microsoft PowerPoint™, users can move graphical objects, but cannot move pushbuttons or context menus. The interactive/collaborative display software embodiment can therefore interpret a user's movement made on an immobile object as applying to the surrounding object, such as the current PowerPoint™ presentation file in this example.

Heuristic C relates to the expectation that users will interact with graphic elements in ways analogous to their interactions with physical objects. For example, interactive/collaborative display software may interpret fingers placed around the perimeter of a graphic element as selecting that graphic element for movement, instead of interpreting the gesture as indicating one click per finger.

Heuristic D may include probabilistic factors related to Heuristics A, B, and C and may include other statistical information.

Details of handling data concerning the instantaneous position of a graphic element depend somewhat on the graphic environment and the type of graphic element. Described in the terminology of the X Window System (a graphical interface for UNIX-compatible operating systems), a client-server architecture may be used, with the server controlling what appears on the screen and the running applications, usually displayed to a user as windows, acting as the clients. A “window manager” exists as a special application that provides easier user control of windows, such as for iconifying and maximizing windows. In the X Window System, the server has access to information indicating the location of every graphic element to be displayed on the screen and can respond to any client request to draw a new graphic element on the screen. The window manager has access to information indicating the location of every window and icon, but not the locations of elements within any application window. Thus, each application controls the flick of elements within that application, a window manager controls the flick of application windows and desktop icons, and the server draws all graphic elements to the screen and informs the affected client and/or graphic element of input events, such as keyboard keystrokes, mouse actions, or (in the case of various embodiments) interactive table/screen contact. Each graphic element may contain fields that indicate its position (e.g., X,Y coordinates) on the screen.

Graphic element contact presents another behavioral choice for an interactive/collaborative display. In one embodiment, which may be suitable for gaming environments, for example, graphic elements may be treated as all existing on a common plane. Under such a treatment, flicked graphic elements may quite often collide with other graphic elements. Most windowed user interfaces, on the other hand, treat each application as existing on a separate plane, and the windows then have a stacking order. In an alternative embodiment, flicked graphic elements “pass over” or “pass under” all other graphic elements on the screen, possibly covering some other graphic elements when the flicked graphic elements come to rest. As in other embodiments discussed herein, algorithms for application windows may apply to objects within an application, to icons, or to other graphic elements.

Environments making use of the collision approach to propelled graphic elements, i.e., allowing collisions, may employ application of per-object elasticity (assignment of an individual elasticity value to each graphic element or class of graphic elements) to provide variable amounts of rebound. An interactive/collaborative display game of pool, for example, may employ nearly inelastic collisions between billiard balls, but more elastic collisions with the virtual rails of the billiard table. Various embodiments may also allow the user or application programmer to specify a “friction” coefficient for background areas. In this way, game programmers can provide low friction for ice hockey and higher friction for soccer balls on grass, for example. Even embodiments for normal windowing environments may select a default “friction” coefficient. The default friction coefficient may balance flick speed with a quantitative measure of a recipient's ability to respond to incoming graphic elements. For embodiments with friction, FIG. 4 is modified by an additional step after step S30, to check for the possibility that motion of the graphic element has stopped before reaching an edge, due to simulated friction.

A second example embodiment illustrates the possibility that users may use a physical tool such as a stylus to make contact with the screen and manipulate graphic elements. In this embodiment such tools have characteristics detectable by the interactive/collaborative display table, e.g., by means of a display table camera or other presently available or future developed sensor. These characteristics may be used to identify the kind of tool used by the user and therefore, in some embodiments, enabling tools having different characteristics to provide different functional behaviors.

A third example embodiment illustrates automatic window rotation for user orientation. Several parameters describe rotation of a propelled graphic element. Among these are rotational acceleration and deceleration of the graphic element, the graphic element(s) that trigger the rotation, and the positions where auto-rotation start and stop for the graphic element. The graphic element may start with a predetermined velocity and deceleration profile. At each step, i.e., increment of time or distance traveled, a window manager software routine computes the distance of the graphic element along its direction of motion to any user, display edge, or token. If the moving graphic element comes within a pre-configured distance or within a calculated distance of another graphic element, viz. an “initial proximity distance,” the window manager starts its rotation. To reduce the computation, one may keep the angular velocity constant. Depending upon processor speed, either a simplified representation such as a “wire frame” drawing or a full drawing can be displayed. The graphic element comes to rest, both in linear displacement and angular orientation, at a distance referred to as the “final proximity distance.” Acceptable default values for the initial and final proximity distances and for the angular velocity may be determined by usability testing. In a particular embodiment, if the difference between the initial and final proximity distances is called the “rotation distance” RD, and the difference between the initial and final angular positions is called the “angular distance” AD, then the angular velocity may be set equal to AD divided by RD to provide constant angular velocity until the graphic element reaches the final proximity distance.

Some additional implementation may include providing that the computer of the interactive/collaborative display table have data identifying the locations of users around it. Various methods for computers to locate users have been developed. With user location data available, the computer may rotate graphic elements to a specific user such as the nearest user, instead of orienting to the nearest display edge.

Determining the direction in which to send a graphic element uses some computation. Pushing graphic elements on a horizontal screen is not yet a familiar action for many users, and friction between fingers and the table surface can cause a “stutter” in flick motion. From a typically non-linear path of user gesture motion, the interactive/collaborative display table manager software computes a straight-line fit. A least-squares fit may be used to advantage because of its reasonable computational cost and its understood behavior. Alternative implementations may be used which weight the latter portion, e.g., the latter half of the user's gesture motion more than earlier portions, assuming that if the user changes his mind about the destination for the graphic element, that change is expressed during the path of the flicking gesture.

A fourth example embodiment illustrates graphic element propulsion across multiple interactive/collaborative display tables. The following is a description of the purposes and implementation of multiple interconnected interactive/collaborative display tables. Some meetings may be interrupted while information is physically being distributed and while attendees are not actively participating due to various reasons. Interactive/collaborative display systems are designed to enable social interactions, providing an environment where information is shared in a social way that allows and encourages collaboration. A desirable meeting room would include an interactive/collaborative display table or multiple, interconnected interactive/collaborative display tables, depending on the size and uses of the room, for example.

Rooms with multiple, interconnected interactive/collaborative display tables may use a client/server model wherein one interactive/collaborative display (typically more powerful than the others) acts as a central file server for meeting data, and each display area gets its data to display from the server. Any changes or production of information are saved to the server to provide real-time sharing and access to the data. An alternative embodiment may provide each interactive/collaborative display with its own data storage and may use widely available synchronization algorithms so that files opened by multiple users remain consistent. This approach is more costly in terms of network and computing utilization than the client/server approach. However, in cases in which few users overlap with respect to documents that they have open, this approach would be more responsive than the client/server approach. In general, interactive/collaborative display systems that have their own file storage capabilities are better suited as stand-alone systems, where real time sharing is not used.

Additionally, the conference room interactive/collaborative displays may appear on a corporate intranet. In such an embodiment, people in a conference room are able to log in and have access to their private data in addition to having access to the shared interactive/collaborative display server. This capability enables easy migration of collaborative work back to private workspaces, and vice versa.

Interconnected interactive/collaborative display tables may be physically interconnected via network technologies such as SCSI, USB 2.0, Firewire, Ethernet, or various wireless network technologies presently available or developed in the future. Each of the interconnected interactive/collaborative display tables has stored data identifying the physical locations of other similar tables relative to its own position.

There are at least two ways for the interconnected interactive/collaborative display systems to acquire data identifying locations and orientations of the other interconnected systems. The first method is a dynamic method that is enabled when the system first powers on. The interactive/collaborative display systems are programmed to go into a “discovery” mode while booting up, wherein they look for nearby connected interactive/collaborative display systems. The second method uses static data provided by users during the initial configuration; the static data describes the location of other connected interactive/collaborative display systems.

Some embodiments of multi-display and/or multi-table interactive/collaborative display systems are programmed to allow a user to send graphic elements to intended destination displays on selected connected systems in real time. The user sends the graphic element toward the intended destination by executing a “flicking” gesture on his own display. The program controlling display of the graphic element determines the direction in which the graphic element was flicked and actively determines its intended destination and correct orientation, via the means described hereinbelow in the discussion of graphic element rotation. Described in the terminology of the X Window System (a graphical interface for UNIX-compatible operating systems), the sending interactive/collaborative display client closes the connection to the current display and opens a new connection on the receiving display. The sending computer has node name information for the receiving computer from the configuration information.

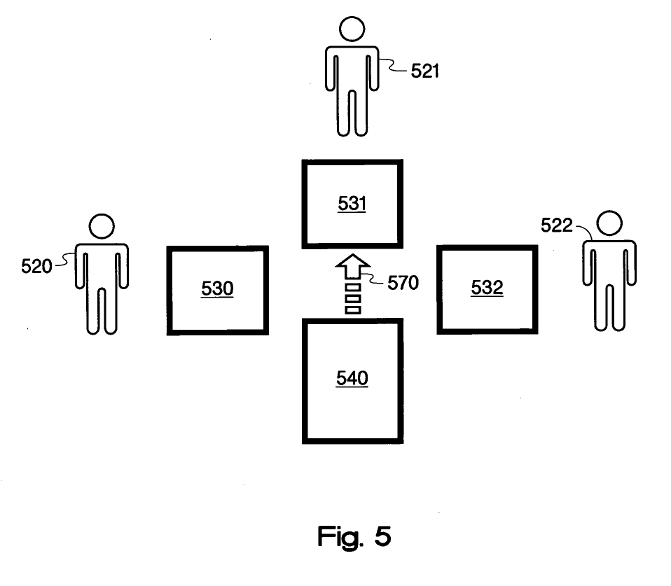

An alternative embodiment allows users to send graphic elements via a software-mapped scheme, using a symbolic map that is displayed by the interactive/collaborative display when a user gestures to share a graphic element. The sender application forms a rendered image of the map as shown in FIG. 5, including the locations of the various interconnected interactive/collaborative display systems, and/or the identities of users who are currently at the tables. The graphic element can then be dragged and dropped on the desired software-mapped destination location, whereupon the system will send the data to the intended destination. FIG. 5 is a “map” illustrating schematically an embodiment of software-implemented direction in selective sharing of graphic elements and the information associated with them among separate interactive display surfaces 30, 31, and 32 used by users 20, 21, and 22 respectively. Interactive display surfaces 30, 31, and 32 are interconnected. The map of FIG. 5 is displayed on the interactive display surfaces of another user (e.g., a fourth user, not shown). In FIG. 5, the rectangles labeled 530, 531, and 532 are graphic elements representing the available drop areas on corresponding interactive display surfaces 30, 31, and 32. Icons labeled 520, 521, and 522 respectively are graphic elements representing the corresponding users 20, 21, and 22. Graphic-element object 540 in the map of FIG. 5 represents a graphic element 40 on a real interactive display surface that is in use by one of the users (e.g., the fourth user). Each of the users has an analogous map on his or her respective display, showing the available drop areas on the other users' interactive display surfaces. As described in detail below, the software selectively directs a graphic element 40 to selected interactive display surface 31 for user 21 (as shown by dashed arrow 570) as when a user moves the graphic-element object labeled 540 along dashed arrow 570 to the graphic icon 531 representing the appropriate drop area on the real interactive display surface 31 of user 21.

Thus, manual manipulation of a graphic element allows a user to transfer graphic elements between users on an interactive/collaborative display table or across multiple interactive/collaborative display tables in an intuitive manner by using natural gestures of flicking an item. The interactive/collaborative display computer computes the graphic element's direction of motion and acceleration, taking into account the presence of any connected interactive/collaborative display tables, to determine the intended destination of the transferred item.

Once the interactive/collaborative display computer determines that the motion-controlling token has completed the propulsion gesture, the computer calculates at least the initial velocity and deceleration of the graphic element, also taking into account the available screen distance in the direction of travel and (in at least some embodiments) taking into account the size of the window.

To provide a natural user experience, the interactive/collaborative display computer may use Newton's laws of motion to control the behavior of graphic elements. It is believed that a user, when propelling a window, may associate a mass or inertia with the window area and expect Newtonian laws to govern its motion accordingly. In this same vein, the interactive/collaborative display may treat the edges of the screen area as if they were made of a perfectly inelastic material. That is, windows will not bounce when coming in contact with the screen edge. In some embodiments, a frictional factor analogous to a physical coefficient of friction may be employed. In the interests of expediency and consistency with other windowing systems, propelled windows may move over other graphic elements and behave as if there were no change in friction when doing so.

Depending upon the available computing power relative to the graphic element complexity, the interactive/collaborative display may represent a graphic element in a simplified form while it is in motion. If multiple users are present, the interactive/collaborative display may orient the graphic element toward the receiving user.

A fifth example embodiment illustrates graphic element propulsion with automatic orientation of the graphic element. A rectangular touch-screen-equipped display surface embodiment was made to demonstrate flicking of a graphic element and automatic orientation of the graphic element. The system has stored data indicating the presence of four users located around the rectangular table. Each user is positioned at one edge of the table. A graphic element is displayed on the table. If a user drags the graphic element relatively slowly and steadily, below a predetermined rate of acceleration, the graphic element follows the user's finger and stops when the user stops hand movement. If the user drags the graphic element into proximity with another user around the table, the graphic element automatically orients itself toward that user. To flick the graphic element, a user performs the flicking gesture described hereinabove, exceeding a pre-determined rate of acceleration. The system senses the rate of acceleration and if the rate is greater than the set value, the graphic element will maintain its momentum after the user releases the graphic element. The momentum of the graphic element will project the graphic element on the designated path until the graphic element reaches a screen edge. Once the graphic element reaches the edge, it automatically orients itself to the user and to the corresponding edge. The interactive/collaborative-display-enabled conference room provides a considerable utility in collaborative computing for groups.

More generally, proximity to other graphic elements or proximity to physical objects located on the table can trigger rotation of moving graphic elements. Among the objects amenable to such treatment are the display edges, other graphic elements, user tokens in screen contact, and user contact areas. Providing embodiments including system behavior effects that are triggered by object proximity opens up a wide range of new user experiences, especially in the areas of games and educational software. As an example, a game of air hockey may be implemented with physical paddles and a digital puck. In addition to its safety, this approach reduces material wear.

Thus, one embodiment includes a method of controlling motion of graphic elements of a display, by detecting a gesture, associating the gesture with a graphic element, determining an acceleration vector of the gesture, initiating propulsion of the graphic element in a chosen direction parallel to the acceleration vector, and comparing the magnitude of the acceleration with a predetermined threshold value. If the magnitude of the acceleration exceeds the predetermined threshold value, a corresponding motion vector is computed for the graphic element and the motion is initiated. Propulsion of the graphic element is continued until the graphic element reaches a predetermined position range. If the magnitude of the acceleration does not exceed the threshold value, propulsion of the graphic element is continued in the chosen direction until the gesture ends. If the graphic element reaches the predetermined position range, the graphic element may be oriented. The step of orienting the graphic element may be performed by rotating the graphic element until a feature of the graphic element is oriented substantially parallel with an edge of the display. The oriented feature may be lines of text or an axis of a graph, for example. For another example, the step of orienting the graphic element may rotate the graphic element in such a way as to orient a selected edge of the graphic element toward an edge of the display. Also, the step of orienting the graphic element may comprise orienting a selected edge of the graphic element toward a user.

To enhance realism, each step of continuing propulsion of the graphic element may be performed by assigning a predetermined inertial factor and/or a predetermined frictional factor to the graphic element and controlling propulsion analogously in accordance with a physical object having inertia proportional to the predetermined inertial factor and having friction proportional to the predetermined frictional factor. The predetermined inertial factor may be proportional to at least one predetermined parameter of the graphic element. For example, the inertial factor may be zero, a non-zero constant, or proportional to the area of the graphic element, to the number of display pixels used by the graphic element, to a memory usage, to a processor-cycle usage, and/or to combinations of two or more of these parameters. The predetermined frictional factor may be proportional to at least one predetermined parameter of the graphic element. For example, the frictional factor may be zero, a non-zero constant, or may be proportional to the area of the graphic element, to the number of display pixels used by the graphic element, to a memory usage, to a processor usage, and/or to combinations of two or more of these parameters.

Another aspect of some embodiments is a method of using a display, including detecting a gesture performed on the surface of the display, associating the gesture with a graphic element displayed on the display, characterizing the gesture by at least one motion value, and updating the display to move the graphic element in accordance with the motion value.

Thus, when a user executes a gesture to propel a graphic element, the gesture may be characterized by at least one motion value; for example, a time of initiating the gesture, an initial position of the gesture, an initial speed of the gesture, a direction of the gesture, an initial velocity of the gesture, an acceleration of the gesture, a final velocity of the gesture, an ending position of the gesture, an ending time of the gesture, and/or combinations of two or more of these motion values. The display may be updated to move the graphic element in accordance with the particular motion value(s) by which the gesture is characterized. For example, initiating propulsion of the graphic element in a chosen direction may include moving the graphic element at an initial velocity determined by the final velocity of the gesture.

In some embodiments, a distinct portion of surface area of the display is associated with each of a number of multiple simultaneous users, and the operation of updating the display to move the graphic element includes moving the graphic element to the distinct portion of surface area of the display associated with one of the multiple simultaneous users.

Another aspect includes embodiments of apparatus including a computer-readable medium carrying computer-executable instructions configured to cause control electronics to perform the methods described hereinabove. From another point of view, embodiments of the apparatus may include a computer-readable medium including computer-executable instructions configured to cause control electronics to receive information for an image captured by an optical receiver, wherein the information includes information corresponding to a gesture made on a display surface. The computer-executable instructions are also configured to interpret the information corresponding to a gesture as a computer command, such as a computer command that includes moving a graphic element on the display surface. Similarly, the computer-readable medium may include computer-executable instructions configured to characterize at least one value characterizing the gesture, such as one of the gesture-motion values listed hereinabove.

Another aspect of embodiments is a system including components for displaying graphic elements, a detection mechanism for detecting a gesture made on the display, and a control mechanism to update display of the graphic elements in accordance with a detected gesture, e.g., for moving the graphic element on that display or another display.

The display(s) of such a system may accommodate multiple simultaneous users. As described above, a distinct portion of surface area may be associated with each one of the multiple simultaneous users. As in the example shown in FIG. 1, at least some, and alternatively all, of the distinct portions of surface area associated with multiple simultaneous users 20 and 21 may be on a single display surface 30. Alternatively, the distinct portion of surface area associated with at least one of the multiple simultaneous users may be on a separate display surface from that of the other users. In yet another alternative, the distinct portions of surface area associated with each of the multiple simultaneous users may each be on a separate display surface. Some embodiments may include communication among the separate display surfaces. As described above, graphic elements may be moved among a number of separate display surfaces if such motions are desired.

Yet another aspect of embodiments is a method for controlling the display of a computer-generated image, including steps of (a) generating a control signal in response to a gesture executed on a graphic element displayed on a display surface (the control signal corresponding to at least one motion value of the gesture), (b) causing an application program running on the computer to execute an application-program operation in response to the control signal, the application-program operation causing the computer-generated image to change in response to the control signal, and (c) causing the computer to display the graphic element associated with the gesture in at least a new position on the display surface. The method may include additional steps of (d) detecting any collisions of the graphic element with any other graphic elements and/or with any edge of the display surface and causing motion of the graphic element to vary accordingly, and (e) re-orienting the graphic element with respect to an edge of the display surface if desired.

When a number of separate display surfaces are interconnected, as in the fourth example embodiment above with multiple interactive/collaborative display tables, the method for controlling display of computer-generated images is similar. In such multiple display systems, the method includes steps of (a) generating a control signal in response to a gesture executed on a graphic element displayed on a first display surface (the control signal corresponding to at least one motion value of the gesture), (b) causing an application computer program to execute an application-program operation in response to the control signal, the application-program operation causing a computer-generated image on at least a second display surface to change in response to the control signal, and (c) causing the computer to display the graphic element associated with the gesture in at least a new position on at least the second display surface. This method for a system with a number of separate display surfaces may include additional steps of (d) detecting any collisions of the graphic element with any other graphic elements and/or with any edge of the second display surface and causing motion of the graphic element to vary accordingly if desired, and (e) re-orienting the graphic element with respect to an edge of the second display surface if desired. In such a system with multiple interactive/collaborative display surfaces, steps (b) through (e) may be performed selectively for the multiple display surfaces, e.g. to direct a graphic element to a selected one or several of the display surfaces.

### INDUSTRIAL APPLICABILITY

Devices made in accordance with the disclosed embodiments are useful in many applications, including business, education, and entertainment, for example. Methods practiced in accordance with disclosed method embodiments may also be used in these and many other applications. Such methods allow users to manipulate graphic elements directly on a screen without using a mouse or other manufactured pointing device. Embodiments disclosed mitigate issues of sharing graphic elements on a single large display surface or on multiple display surfaces networked together.

An interactive/collaborative-display-enabled conference room provides considerable utility in collaborative computing for groups of multiple simultaneous users. Users are enabled to use intuitive gestures such as flicking. Automatic rotation of propelled graphic elements provides novel aspects of the user experience and enables novel possibilities for a windowing system.

The methods described provide ways to share data easily among connected interactive/collaborative display systems in real time. This allows for multi-user review and revision of presented data. Graphic elements can be shared in a way that is intuitive and natural, by “flicking” the data to the desired location.

Apparatus made in accordance with the disclosed embodiments and methods practiced according to disclosed method embodiments are especially adaptable for empowering users with limited mobility or physical handicaps. For example, the interactive/collaborative display table having a sensor to detect characteristics of tools used by such a user may enable various enhanced functional behaviors of the system.

Although the foregoing has been a description and illustration of specific embodiments, various modifications and changes thereto can be made by persons skilled in the art without departing from the scope and spirit defined by the following claims. For example, the order of method steps may be varied from the embodiments disclosed, and various kinds of touch-screen technology may be employed when implementing the methods and apparatus disclosed.

What is claimed is:

1. A method, comprising:
a) detecting a gesture,
b) associating the gesture with a graphic element of a display,
c) determining an acceleration vector of the gesture,
d) initiating propulsion of the graphic element in a chosen direction parallel to the acceleration vector,
e) comparing a magnitude of the acceleration with a predetermined threshold value, and
i) if the magnitude of the acceleration exceeds the predetermined threshold value, then continuing propulsion of the graphic element until the graphic element reaches a predetermined position range,
ii) if the magnitude of the acceleration does not exceed the threshold value, then continuing propulsion of the graphic element in the chosen direction until the gesture ends.

2. The method of claim 1, further comprising:
f) if the graphic element reaches the predetermined position range, then orienting the graphic element, wherein orienting the graphic element comprises rotating the graphic element until a feature of the graphic element is oriented substantially parallel with an edge of the display.

3. The method of claim 2, wherein orienting the graphic element further comprises rotating the graphic element to orient a selected edge of the graphic element toward an edge of the display.

4. The method of claim 1, further comprising:
f) if the graphic element reaches the predetermined position range, then orienting the graphic element, wherein orienting the graphic element comprises orienting a selected edge of the graphic element toward a user.

5. The method of claim 1, wherein the continuing propulsion of the graphic element is performed by assigning a predetermined inertial factor and a predetermined frictional factor to the graphic element and controlling propulsion analogously in accordance with a physical object having inertia proportional to the predetermined inertial factor and having friction proportional to the predetermined frictional factor.

6. The method of claim 5, wherein the predetermined inertial factor is proportional to at least one predetermined parameter of the graphic element selected from the list consisting of: zero, a non-zero constant, the area of the graphic element, the number of display pixels used by the graphic element, a memory usage, a processor usage, and combinations of two or more of these parameters.

7. The method of claim 5, wherein the predetermined frictional factor is proportional to at least one predetermined parameter of the graphic element selected from the list consisting of: zero, a non-zero constant, the area of the graphic element, the number of display pixels used by the graphic element, a memory usage, a processor usage, and combinations of two or more of these parameters.

8. The method of claim 1, wherein the gesture is further characterized by at least one value selected from the list consisting of:
a) a time of initiating the gesture,
b) an initial position of the gesture,
c) an initial speed of the gesture,
d) a direction of the gesture,
e) an initial velocity of the gesture,
f) a final velocity of the gesture,
g) an ending position of the gesture,
h) an ending time of the gesture,
i) combinations of one or more of these values with the acceleration, and
j) combinations of two or more of these values with each other.

9. The method of claim 1, wherein the initiating propulsion of the graphic element in a chosen direction comprises moving the graphic element at an initial velocity determined by the final velocity of the gesture.

10. An apparatus comprising a computer-readable medium including computer-executable instructions configured to cause control electronics to perform the method of claim 1.

11. An apparatus comprising a computer-readable medium including computer-executable instructions configured to cause control electronics to:
a) receive information for an image captured by an optical receiver, including information corresponding to at least a magnitude of an acceleration characterizing a gesture; and
b) interpret the information corresponding to the gesture as a computer command.

12. The apparatus of claim 11, wherein the computer command includes moving a graphic element on the display surface.

13. The apparatus of claim 11, wherein the computer-readable medium includes computer-executable instructions configured to characterize at least one value characterizing the gesture.

14. The apparatus of claim 13, wherein the at least one value characterizing the gesture comprises at least one value selected from the list consisting of:
a) a time of initiating the gesture,
b) an initial position of the gesture,
c) an initial speed of the gesture,
d) a direction of the gesture,
e) an initial velocity of the gesture,
f) a final velocity of the gesture,
g) an ending position of the gesture,
h) an ending time of the gesture,
i) combinations of one or more of these values with the acceleration, and
j) combinations of two or more of these values with each other.

15. A system comprising:
a) means for displaying graphic elements,
b) means for detecting a gesture made on the means for displaying, and
c) means for updating the means for displaying graphic elements in accordance with a gesture detected.

16. The system of claim 15, wherein the means for updating the means for displaying includes means for moving a graphic element.

17. The system of claim 15, wherein the means for displaying graphic elements accommodates multiple simultaneous users.

18. The system of claim 17, wherein the means for displaying graphic elements includes means for associating a distinct portion of surface area with each of the multiple simultaneous users.

19. The system of claim 18, wherein at least some of the distinct portions of surface area associated with multiple simultaneous users are on a single display surface.

20. The system of claim 18, wherein all of the distinct portions of surface area associated with multiple simultaneous users are on a single display surface.

21. The system of claim 18, wherein at least one distinct portion of surface area associated with at least one of the multiple simultaneous users is on a separate display surface, the system further comprising means for communicating among the separate display surfaces.

22. The system of claim 21, further comprising means for moving graphic elements among the separate display surfaces.

23. The system of claim 18, wherein the distinct portion of surface area associated with each of the multiple simultaneous users is on a separate display surface, the system further comprising means for communicating among the separate display surfaces

24. A method, comprising:
a) detecting a gesture performed on a surface of a display,
b) associating the gesture with a graphic element displayed on the display,
c) characterizing the gesture by at least one motion value including an acceleration, and
d) updating the display to move the graphic element in accordance with the at least one motion value.

25. The method of claim 24, wherein the at least one motion value including an acceleration further comprises at least one value selected from the list consisting of:
a time of initiating, an initial position, an initial speed, a direction, an initial velocity, a final velocity, an ending position, an ending time, combinations of one or more of these values with the acceleration, and combinations of two or more of these values with each other.

26. The method of claim 24, further comprising associating a distinct portion of surface area of the display with each of a number of multiple simultaneous users.

27. The method of claim 26, wherein the updating the display to move the graphic element includes moving the graphic element to the distinct portion of surface area of the display associated with one of the number of multiple simultaneous users.

28. A method for controlling display of a computer-generated image, the method comprising:
a) generating a control signal in response to a gesture executed on a graphic element displayed on a first display surface, the control signal corresponding to at least one motion value of the gesture;
b) causing an application computer program to execute an application-program operation in response to the control signal, the application-program operation causing a computer-generated image on at least a second display surface to change in response to the control signal;
c) causing the computer to display the graphic element associated with the gesture in at least a new position on at least the second display surface;
d) if desired, detecting any collisions of the graphic element with any other graphic elements and/or with any edge of the second display surface and optionally causing motion of the graphic element to vary accordingly; and
e) if desired, re-orienting the graphic element with respect to an edge of the second display surface.

29. The method of claim 28, wherein steps b) through e) are performed selectively for multiple display surfaces.

30. The method of claim 28, wherein the first and second display surfaces are combined in one and the same display surface.
